(19) United States
(12) Patent Application Publication
(10) Pub. No.: US 2024/0169113 A1
(43) Pub. Date: May 23, 2024

(54) STIFFNESS AND STRENGTH-BASED CONCURRENT SHAPE AND FIBER PATH OPTIMIZATION OF CONTINUOUS FIBER COMPOSITES

(71) Applicant: Embry-Riddle Aeronautical University, Inc., Daytona Beach, FL (US)

(72) Inventors: Zhelong He, Ormond Beach, FL (US); Ali Tamijani, Ormond Beach, FL (US)

(21) Appl. No.: 18/179,217

(22) Filed: Mar. 6, 2023

Related U.S. Application Data
(60) Provisional application No. 63/317,255, filed on Mar. 7, 2022.

(51) Int. Cl. G06F 30/20; B29C 70/24; B29K 105/10

(52) U.S. Cl. CPC G06F 30/20; B29C 70/24; B29K 2105/101

(57) ABSTRACT

A computer-implemented method of optimizing a computer model including a shape and a fiber path for a continuous fiber composite can include initializing a fixed finite element mesh. The method can also include creating an updated version of the shape and the fiber path by iterating updates of the shape and the fiber path using the fixed finite element mesh. The method can also include initializing an adapted finite element mesh on the updated version of the shape and the fiber path. The method can also include creating an optimized version of the shape and the fiber path by iterating optimizations of the shape and the fiber path using the adapted finite element mesh. The method can also include generating a specified design of the continuous fiber composite using the optimized version of the shape and the fiber path.

### CLAIM OF PRIORITY

This patent application claims the benefit of priority, under 35 U.S.C. Section 119(e), to Zhelong He U.S. Patent Application Ser. No. 63/317,255, entitled “STIFFNESS AND STRENGTH-BASED CONCURRENT SHAPE AND FIBER PATH OPTIMIZATION OF CONTINUOUS FIBER COMPOSITES,” filed on Mar. 7, 2022 (Attorney Docket No. 4568.014PRV), which is hereby incorporated by reference herein in its entirety.

### STATEMENT REGARDING FEDERALLY SPONSORED RESEARCH OR DEVELOPMENT

This invention was made with government support under award number N00014-20-1-2683 awarded by The Office of Naval Research. The government has certain rights in the invention.

### BACKGROUND

Continuous fiber composites are geometrically characterized by a very high length-to-diameter ratio (e.g., aspect ratio) and are generally stronger and stiffer than bulk materials. Continuous fibers can be reinforced with composite materials (e.g., carbon, glass, aramid (e.g., such as under trade name Kevlar® and Twaron®), boron, high-performance polypropylene (PP), ultra-high molecular weight polyethylene (PE), polyp-phenylene-2,6-benzobisoxazole (PBO), and hybrid combinations thereof to increase the material's specific strength or specific stiffness, and its fatigue resistance.

Continuous fiber composite materials have a variety of uses, such as in: dental appliances; turbines for (e.g., for automotive, aerospace, or marine vehicle applications); medical devices; in personal protective equipment; footwear; sporting goods; industrial equipment; packaging and construction materials; impellers; blades; energy storage devices; electronics; optical devices; and in oil and gas applications.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates a flowchart of an example of a method for shape and fiber path optimization of a continuous fiber composite.

FIG. 2A illustrates a shape with infilled fibers of an L-bracket that uses a level-set method on fixed mesh for failure index minimization at 0 iterations.

FIG. 2B illustrates a shape with infilled fibers of an L-bracket that uses a level-set method on fixed mesh for failure index minimization at 300 iterations.

FIG. 2C illustrates a shape with infilled fibers of an L-bracket that uses a level-set method on fixed mesh for failure index minimization at 500 iterations.

FIG. 2D illustrates a shape with infilled fibers of an L-bracket that uses a level-set method on fixed mesh for failure index minimization at 600 iterations.

FIG. 3A illustrates a shape with infilled fibers of an L-bracket that can be optimized for maximizing strength with horizontal fibers.

FIG. 3B illustrates a shape with infilled fibers of an L-bracket that can be optimized for maximizing strength with vertical fibers.

FIG. 4A illustrates a zero level-set isoline on a fixed mesh.

FIG. 4B illustrates a zero level-set isoline on a level-set based evolutionary mesh.

FIG. 5 illustrates a flowchart of an example of a method for shape and fiber path optimization of a continuous fiber composite.

FIG. 6 illustrates a flowchart of an example of a method for shape and fiber path optimization of a continuous fiber composite.

FIG. 7 illustrates a flowchart of an example of a method for shape and fiber path optimization of a continuous fiber composite.

FIG. 8 illustrates a flowchart of an example of a method for shape and fiber path optimization of a continuous fiber composite.

FIG. 9 illustrates a flowchart of an example of a method for shape and fiber path optimization of a continuous fiber composite.

FIG. 10 illustrates a flowchart of an example of a method for shape and fiber path optimization of a continuous fiber composite.

FIG. 11 illustrates fiber orientations of a square plate calculated by using Equation 4.

FIG. 12A illustrates a schematic of a plate with fiber orientations before revision.

FIG. 12B illustrates a schematic of a plate with fiber orientations after revision.

FIG. 13A illustrates a shape with infilled fibers of a 3-point bending example that can be optimized for failure index minimization using a classical level-set method on fixed mesh.

FIG. 13B illustrates a shape with infilled fibers of a 3-point bending example that uses a classical level-set method on fixed mesh.

FIG. 13C is a shape with infilled fibers of a 3-point bending example optimized for failure index minimization with thickness control.

FIG. 13D is a shape with infilled fibers of a 3-point bending example that can be optimized for compliance minimization with thickness control.

FIG. 14 is a block diagram illustrating an example of a machine upon which one or more examples may be implemented.

### DETAILED DESCRIPTION

The performance of structures, such as load-carrying capacity, thermal conductance, eigenfrequency, and aeroelastic characteristics, can be enhanced by optimizing the shape and topology of the structures. This can be specifically true for composite materials with anisotropic properties that can enhance their structural performance. One optimization scheme for composites can be to align the fibers with the major principal stress or strain directions. However, optimized fiber orientations tend to be sensitive to the initial fiber configurations. This fiber optimization approach can be a non-convex problem. Also, this optimization approach can be difficult to manufacture. This difficulty can be due to the abrupt change of fiber path between adjacent elements.

Automated fiber placement and additive manufacturing technologies can allow for placing continuous composite fibers along curvilinear paths. Different curvilinear parameterization schemes can represent fiber paths, such as Bezier curves, geodesic paths, constant angle paths, paths with linearly varying fiber angles, and constant curvature paths. A level-set method can be used to change a path of the fibers. For example, in a level-set method, a continuous level-set function can define the fiber paths. This can make the fiber paths equally spaced. The fiber paths can be updated by solving a Hamilton-Jacobi equation, which can converge to an optimized configuration for compliance minimization.

Concurrent topology and continuous fiber path optimization can be used. This approach can allow for various combinations of optimized properties and manufacturability. For example, a concurrent process under a unified level-set framework can be employed. The level-set technique can be used to calculate the fiber deposition path, such as by extracting the iso-value level-set contours and conducting topology optimization. A density-based approach and the level-set method can obtain the optimized continuous fiber paths and material distribution to enhance the mechanical performance of composite structures. Hybrid topology optimization for multi-patch fused deposition modeling 3D printing can concurrently optimize the topology of the printing layer, multi-patch distribution, and deposition directions. A bi-material density-based topology optimization scheme can include a full-scale method to concurrently optimize for structural topology, continuous fiber path, and morphology, or can be focused on optimizing stiffness.

Strength is another factor that influences the performance of a structure. Compared with a compliance minimization approach, stress minimization can be more challenging due to its local nature and non-linearity of its variables. An extended finite element method can be combined with a level-set description of geometry, such as to help reduce or minimize the stress concentration in a two-dimensional (2D) filet in tension. Coupling the level-set method with topological derivatives can help reduce or minimize stress with shape and topology. Minimizing the stress or imposing the stress as a constraint, can involve primarily focusing on isotropic materials.

Materials with anisotropy can be widely useful in engineering. However, anisotropic materials' strength-based shape and topology optimization has been little studied. A topological sensitivity formulation based on the strength ratio of non-homogeneous failure criteria can be included in the topology optimization, such as using the level-set method. This can help provide new insight for conducting strength-based optimization of anisotropic materials.

This disclosure relates to a novel strength-based structural optimization technique that can be capable of concurrently designing a shape and fiber paths in continuous fiber-reinforced composites. To this end, a higher-order function, such as a level-set function, can be used to update both shape and fiber placement. A shape evolution can involve shape sensitivity analysis, such as can be based on the Tsai-Wu failure criterion. A fiber path evolution can depend on the level-set function determined from the shape boundary. To ensure the efficiency and accuracy of the process, a scheme can combine a level-set method using fixed mesh and a level-set-based mesh evolution (e.g., an adapted finite element mesh). A revision operation over fiber orientations along the shape skeleton can help alleviate the local failure index singularity along the boundary or skeleton of the composite. A thickness control term can be used, such as to help set a thickness penalty to help avoid over-thin portions of articles made from continuous fiber composites. The thickness penalty can help ensure the continuous fiber composite's manufacturability.

An example of a level-set method that can be used is discussed here, such as for shape optimization. The level-set method can employ a higher-dimensional function, p, to implicitly represent shape boundaries, such as using the following forms:

$$\{ \begin{matrix}ϕ ( x ) > 0 & x ∈ Ω \\ ϕ ( x ) = 0 & x ∈ Γ \\ ϕ ( x ) < 0 & x ∈ D / ( Ω ⋃ Γ )\end{matrix} \qquad ( 1 )$$

where Ω can be the shape, D can be the working domain, and Γ can be the boundary of design and can include two parts, Γ_{D} with a Dirichlet boundary condition and Γ_{N} with a Neumann boundary condition.

The design boundary, Γ, can be optimized iteratively, such as by using the following Hamilton-Jacobi equation:

$$\frac{\partial ϕ ( x , t )}{\partial t} + {V}_{n} \vert ∇ ϕ \vert = 0 \qquad ( 2 )$$

where Vₙ can represent the boundary velocity of the shape in the normal direction, obtained from the shape sensitivity analysis, as explained in the following subsection. A new level-set function can then be obtained as follows:

ϕ^{k+1}=ϕ^{k}−Δt|∇ϕ^{k}|Vₙ (3)

where k can represent the iteration number. To regularize the level-set function, it can be reinitialized recurrently or periodically, such as to become the signed distance function. Then, an updated shape can be obtained, such as using the updated and regularized level-set function.

The level-set method can also be used for fiber path planning, assuming a constant fiber orientation within each element along the tangential direction of the level-set function or perpendicular to the gradient of the level-set function:

$$θ = {tan}^{- 1} ( - \frac{d ϕ}{dx} , \frac{d ϕ}{dy} ) \qquad ( 4 )$$

Once a new level-set function is determined, the fiber orientation, θ, at each element can be determined by Eq. (4). Then, the stiffness tensor, C, can be determined through a transformation matrix, R, as C(θ)=R(θ)C₀R^{T}(θ), which can also be used in a sequential shape optimization process.

Strength-based optimization can be implemented using one or more of the following examples. The failure index (also referred to as the strength ratio) γₑ=1/sₑ can be manipulated, such as by maximizing a positive safety factor s, or by minimizing its reverse. The definition of safety factor, sₑ, can be:

Asₑ²+Bsₑ−1=0 (5)

which can yield:

$${s}_{e} = \frac{- B + \sqrt{{B}^{2} + 4 A}}{2 A} \qquad ( 6 )$$

$$and$$

$${γ}_{e} = \frac{1}{{s}_{e}} \qquad ( 7 )$$

The indices A and B in Eq. (5) can be taken from the Tsai-Wu failure criterion and can have the following forms for a 2D problem:

A=F₁₁σ₁₁²+F₂₂σ₂₂²+F₆₆σ₁₂²+2F₂σ₁₁σ₂₂

B=F₁σ₁₁+F₂σ₂₂ (8)

In the above equation, σᵢⱼ(y=11,22,12) can represent the stress tensor in a fiber coordinate system, and the coefficients Fᵢ(i=1,2), Fᵢⱼ(ij=11,22,12,66) can be:

$${F}_{1} = \frac{1}{{X}_{t}} - \frac{1}{{X}_{c}} , {F}_{2} = \frac{1}{{Y}_{t}} - \frac{1}{{Y}_{c}} \qquad ( 9 )$$

$${F}_{11} = \frac{1}{{X}_{t} {X}_{c}} , {F}_{22} = \frac{1}{{Y}_{t} {Y}_{c}} , {F}_{66} = \frac{1}{{S}^{2}} , {F}_{12} = - \frac{\sqrt{{F}_{11} {F}_{22}}}{2}$$

where Xₜ, Xₑ can be tensile and compressive strengths in the fiber direction (1-direction), Yₜ, Yₑ can be tensile and compressive strengths in a transverse direction (2-direction), and Scan be the in-plane shear strength. For the examples described herein, the material properties can be assumed to be constant. However, these examples can be used on continuous fiber composites of many different material properties.

Furthermore, a global aggregation of failure index, γₑ, using a p-Norm function can be found as follows:

γ=[∫_{Ω}j(x)dΩ]^{1/p},j(x)=k(x)γₑ^{p} (10)

where k(x) can be a piecewise constant function that takes very small values in a region adjacent to the loading area and one elsewhere. As shown in Eq. (10), the larger the value of p is, the closer γ is to the largest value of γₑ in Ω.

The shape optimization problem can be written as follows:

minimize γ(Ω)

subject to a(u,v)=l(v)

V≤Vₘₐₓ (11)

where V can be a volume of the shape, Vₘₐₓ can be a maximum allowable volume of the shape, and a(u,v) can be of the following form:

a(u,v)=∫_{Ω}C(θ)ε(u)ε(v)dΩ (12)

where C(θ) can be a stiffness tensor after the fiber rotation and ε can be a strain. l(v) in Eq. (11) can have the following form:

l(v)=∫_{Ω}bvdΩ+∫_{Γ}_{_{N}}fvdΓ (13)

An adjoint sensitivity analysis can be used to determine shape derivatives. For simplicity, the following functional can be introduced without considering a volume constraint at the current stage:

Λ=γ(Ω)+a(u,λ)−l(λ) (14)

with the following shape derivative

$${Λ}^{′} = {γ}^{′} ( Ω ) + {a}^{′} ( u , λ ) - {l}^{′} ( λ ) \qquad ( 15 )$$

$$where$$

$${γ}^{′} ( Ω ) = \frac{1}{p} {γ}^{1 - p} \{ {\int }_{Ω} \frac{dj}{d σ} [ {C}^{′} ε ( u ) + C ε ( {u}^{′} ) ] d Ω + {\int }_{\partial Ω} j ( g \cdot n ) d Γ \} \qquad ( 16 )$$

$${a}^{′} ( u , λ ) = {\int }_{Ω} {C}^{′} ε ( u ) ε ( λ ) d Ω + {\int }_{Ω} C ε ( {u}^{′} ) ε ( λ ) d Ω + {\int }_{Ω} C ε ( u ) ε ( {λ}^{′} ) d Ω + {\int }_{\partial Ω} C ε ( u ) ε ( λ ) g \cdot n d Γ$$

$${l}^{′} ( λ ) = {\int }_{Ω} b {λ}^{′} d Ω + {\int }_{\partial Ω} b λ g \cdot nd Ω + {\int }_{{Γ}_{N}} τ {λ}^{′} d Γ$$

In Eq. (16), the symbol c can represent a stress vector in the physical coordinate, g can be shape velocity and n can be the normal direction. Substituting Eq. (16) into Eq. (15), collecting terms containing χ′ in Eq. (15), and setting their sum to zero results in a state equation. Collecting the terms containing u′ in Eq. (15) and setting their sum to zero results in an adjoint equation, as follows:

$$\frac{1}{q} {γ}^{1 - q} {\int }_{Ω} \frac{dj}{d σ} C ε ( {u}^{′} ) d Ω + {\int }_{Ω} C ε ( {u}^{′} ) ε ( p ) d Ω = 0 \qquad ( 17 )$$

A body force, b, can be neglected, and by collecting the remaining terms in Eq. (15), the following shape derivative can be obtained:

$${γ}^{′} ( Ω ) = - {\int }_{\partial Ω} {g}_{1} {V}_{n} d Γ - {\int }_{Ω} {g}_{2} ( g \cdot n ) d Ω \qquad ( 18 )$$

$$where$$

$$\begin{matrix}{g}_{1} = - [ \frac{1}{p} {γ}^{1 - p} j + C ε ( u ) ε ( λ ) ] & ( 19 )\end{matrix}$$

$${g}_{2} = - [ \frac{1}{p} {γ}^{1 - p} \frac{dj}{d σ} + ε ( λ ) ] ε ( u ) \frac{\partial C}{\partial θ} \frac{\partial θ}{\partial ϕ}$$

A shape derivative of stiffness tensor C can be incorporated in Eq. (19), as follows:

$${C}^{′} = \frac{\partial C}{\partial θ} \frac{\partial θ}{\partial ϕ} \frac{\partial ϕ}{\partial x} \frac{\partial x}{\partial t} = \frac{\partial C}{\partial θ} \frac{\partial θ}{\partial ϕ} ∇ ϕ \cdot g \qquad ( 20 )$$

$$with$$

$$\begin{matrix}\frac{\partial C}{\partial θ} = 2 \frac{\partial R}{\partial ϕ} {C}_{0} {R}^{T} & ( 21 )\end{matrix}$$

$$and$$

$$\frac{\partial θ}{\partial ϕ} = \frac{( \frac{\partial ϕ}{\partial x} ) \frac{\partial }{\partial ϕ} ( \frac{\partial ϕ}{\partial y} ) - ( \frac{\partial ϕ}{\partial y} ) \frac{\partial }{\partial ϕ} ( \frac{\partial ϕ}{\partial x} )}{{( \frac{\partial ϕ}{\partial x} )}^{2} + {( \frac{\partial ϕ}{\partial y} )}^{2}} \qquad ( 22 )$$

following the definition of θ in Eq. (4).

In finite element analysis, Eq. (22) can be conducted at each element with respect to the surrounding nodes. ϕ in each element can be expressed using nodal value ϕᵢ and shape function Nᵢ, as follows:

$$ϕ = {\sum }_{i = 1}^{n} {N}_{i} {ϕ}_{i} \qquad ( 23 )$$

where n can be a number of nodal points in an element. By substituting Eq. (23) into (22), we get its expression at each element with respect to the local node i, as follows:

$$\frac{\partial θ}{\partial {ϕ}_{i}} = \frac{( \frac{\partial ϕ}{\partial x} ) ( \frac{\partial {N}_{i}}{\partial y} ) - ( \frac{\partial ϕ}{\partial y} ) ( \frac{\partial {N}_{i}}{\partial x} )}{{( \frac{\partial ϕ}{\partial x} )}^{2} + {( \frac{\partial ϕ}{\partial y} )}^{2}} \qquad ( 24 )$$

with Eqs. (20)-(24), the g₂ term in Eq. (19) can be expressed.

The g₁ term can be inserted in Eq. (18), and by choosing Vₙ=g₁ on ∂Ω and extending a range to an entire working domain, the decrease of augmented function A can be ensured. Indeed, introducing g₂ complicates the situation, this is probably why other approaches may have neglected the influence of this term. The terms g₁ and g₂ can be represented on a boundary and inside a domain by extending and regularizing them together to obtain the velocity, g, in an entire working domain, D, as shown here:

∫_{D}(α²∇g·∇v+g·v)=∫_{∂Ω}g₁(v·n)dΓ+∫_{Ω}g₂(v·∇ϕ)dΩ (25)

where α can be a small regularization parameter, g₁ and g₂ can be given in Eq. (19). Thus, a shape velocity g can be obtained at each node of the working domain D, and further used for shape evolution.

The volume constraint in Eq. (11) can be achieved using the augmented Lagrangian method, thus the updated Lagrangian becomes:

$$L ( Ω ) = γ ( Ω ) + \frac{b}{2} max {\{ \frac{l}{b} + \frac{V}{{V}_{max}} - 1 , 0 \}}^{2} \qquad ( 26 )$$

where b can be a penalization parameter and l can be the Lagrange multiplier. Both parameters can be updated using the following scheme:

$$l \to max \{ l + b ( \frac{V}{{V}_{max}} - 1 ) , 0 \} \qquad ( 27 )$$

$$b \to min \{ β b , {b}_{max} \}$$

where β can be a positive coefficient larger than one. Finally, the shape derivative of g₁ in Eq. (19) can incorporate an influence of volume. Thus, the following revision can be performed:

$${g}_{1} \to {g}_{1} - \frac{b}{{V}_{max}} max \{ \frac{l}{b} + \frac{V}{{V}_{max}} - 1 , 0 \} \qquad ( 28 )$$

Level-set methods can be combined, such as using both a fixed mesh and a mesh evolution method (e.g., an adapted finite element mesh). In a first stage, a level-set method with a fixed mesh discretizing a working domain can be used. A so-called “ersatz material” can be used to extend an elasticity and adjoint equation into the entire domain. The Hamilton-Jacobi equation can be solved to account for a shape evolution. An advantage of this method lies in its robustness and efficiency. However, for an optimized design obtained in this stage, the shape's boundaries are not always smooth, resulting in artificial stress perturbation, as demonstrated later in the numerical examples. This occurs since the level-set function can be defined on fixed nodes, and the fixed position of nodes may artificially influence the path of a level-set function. A second stage of optimization can be performed using a level-set-based mesh evolution method to resolve this issue. In this method, starting from the optimized, or almost optimized design from the first stage, the domain can be discretized with mesh adjusted to the level-set function with zero iso-value. Subsequently, the state and adjoint equations can be calculated on the mesh corresponding to the rigid part, and the Hamilton-Jacobi equation can be solved. This process can continue until convergence. Note that the parameters used in the first stage can be kept when entering the second stage. As illustrated later in numerical examples, this combination method can result in a smoother shape boundary and local stress field.

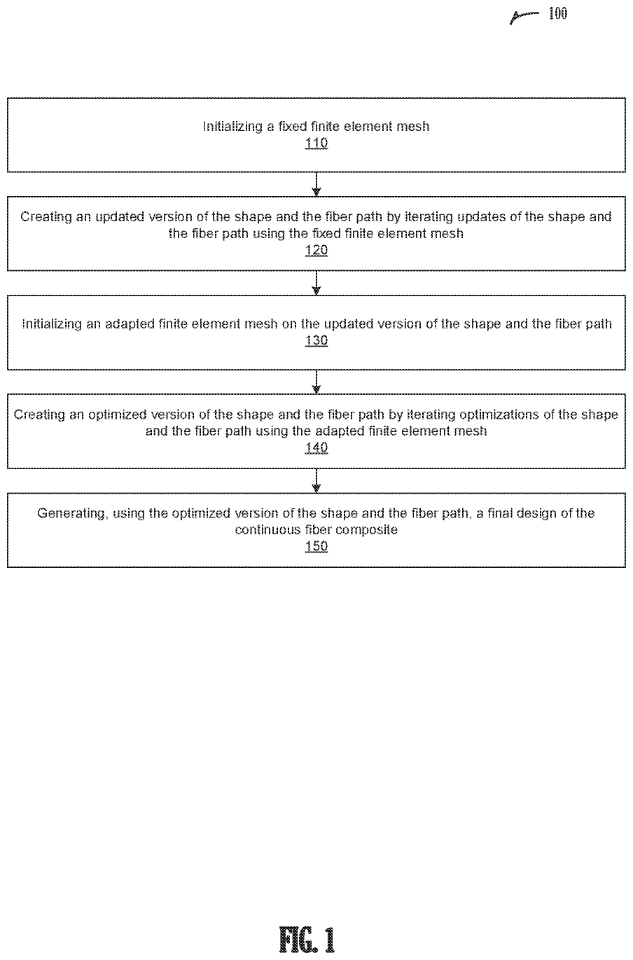

FIG. 1 is a flowchart that describes a method 100 that can include optimizing a shape and a fiber path for a continuous fiber composite.

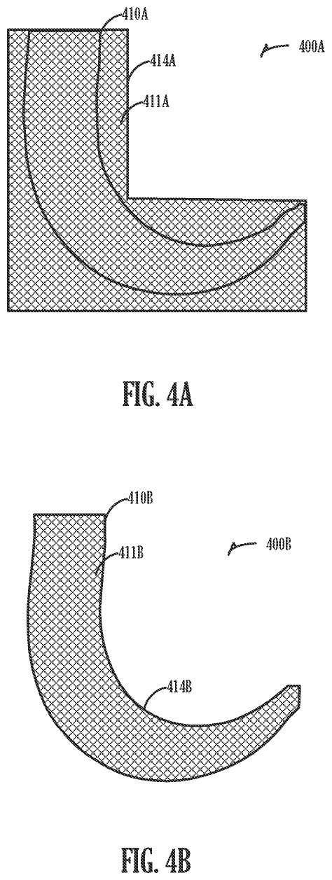

At operation 110, the method 100 can include initializing a fixed finite element mesh. The fixed finite element mesh is discussed in more detail below with reference to FIG. 4B. The fixed finite element mesh can include a first set of material properties and a first set of optimization parameters. The material properties can include the current material properties of the composite, desired material properties of the optimized shape and fiber path of the composite, or any other material properties that can be used during finite element analysis. The optimization parameters can be selected to use any of the formulas described herein, or using any additional parameters, such as thickness control and skeleton revision, as described herein.

At operation 120, the method 100 can include creating an updated version of the shape and the fiber path by iterating updates of the shape and the fiber path using the fixed finite element mesh. The updated version of the shape and the fiber path can be created by using the fixed finite element mesh and one or more strength-based design principles for shape and fiber path optimization. For example, the shape and the fiber path of the continuous fiber composite can be improved by a fixed finite element mesh running any of the equations described herein, any other strength or path optimization equations, or the like. Operation 120 and the fixed finite element analysis used to create the updated version of the shape and the fiber path are discussed in more detail herein.

For example, operation 120 can also include updating the level-set function of Equation (3) using a step size Δt, reinitializing the level-set function of Equation (3) periodically, finding a corresponding new shape and fiber paths, and revising a skeleton fiber orientation. A new objective can then be calculated. If the new objective is not decreased, the step size Δt can be reduced and at least a portion of operation 120 can be rerun. If the new objective is decreased, at least a portion of operation 120 can be rerun to create a next iteration if the update has not converged.

At operation 130, the method 100 can include initializing an adapted finite element mesh on the updated version of the shape and the fiber path. The adapted finite element mesh is described herein with reference to FIG. 4B. The adapted finite element mesh can include a second set of material properties that can be different from the first set of material properties and a second set of optimization parameters that can be different from the first set of optimization parameters. The adapted finite element mesh can include the first set of material properties and the first set of optimization parameters. Here, the material properties and optimization parameters can remain the same between the fixed and adapted finite element analysis.

At operation 140, the method 100 can include creating an optimized version of the shape and the fiber path, such as by iterating optimizations of the shape and the fiber path using the adapted finite element mesh. The updated version of the shape and the fiber path can be created by using the adapted finite element mesh and one or more strength-based design principles for shape and fiber path optimization. For example, the shape and the fiber path of the continuous fiber composite can be improved by the adapted finite element mesh running any of the equations described herein, any other strength or path optimization equations, or the like. Operation 140 and the adapted finite element analysis used to create the updated version of the shape and the fiber path will be discussed in more detail herein.

For example, operation 140 can include re-meshing a shape of the updated design from operation 120 and using a level-set-based mesh evolution method (e.g., an adapted finite element mesh). Operation 140 can then include calculating a state equation and an adjoint equation to find a shape velocity. The shape velocity can be revised using Equation (37), for example, when a thickness control is imposed. The shape velocity can then be extended to a working domain of the entire continuous fiber composite and a new level-set function can be found. After the new level-set function is found, the adapted finite element mesh can be re-initialized. The optimized shape and fiber orientation can be improved with skeleton fiber orientation revision and checking for the convergence of objective function to determine whether to continue the iterations or to stop at the optimized design.

At operation 150, the method 100 can include generating a specified design of the continuous fiber composite using the optimized version of the shape and the fiber path. The specified design can be a continuous fiber composite updated with the fixed finite element mesh and the adapted finite element mesh, each of which can use one or more of the formulas described herein. The specified design, the fixed finite element analysis, and the adapted finite element analysis will be discussed in more detail herein.

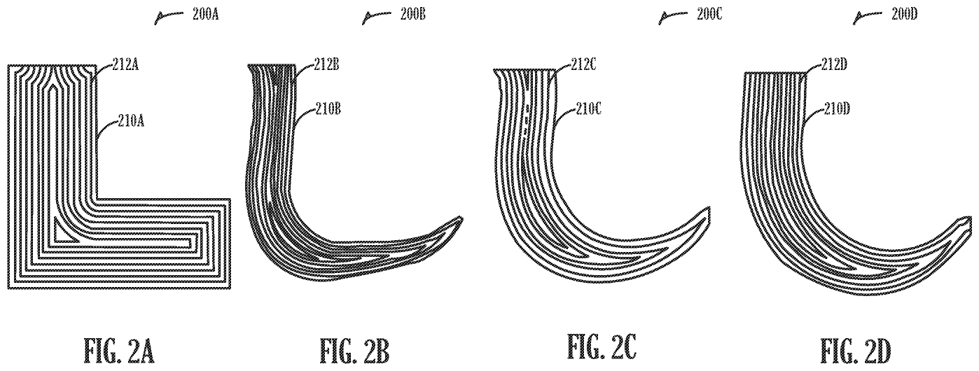

FIG. 2A illustrates a shape 210A with infilled fibers 212A of an apparatus 200A that uses a level-set method on fixed mesh for failure index minimization at 0 iterations. FIG. 2B illustrates the shape 210B with infilled fibers 212B of the apparatus 200B that uses a level-set method on fixed mesh for failure index minimization at 300 iterations. FIG. 2C illustrates the shape 210C with infilled fibers 212C of the apparatus 200C that uses a level-set method on fixed mesh for failure index minimization at 500 iterations. FIG. 2D illustrates the shape 210D with infilled fibers 212D of the apparatus 200D that uses a level-set method on fixed mesh for failure index minimization at 600 iterations. FIGS. 2A-2D will be discussed together below.

The apparatus 200, as shown in FIGS. 2A-2D is an example of an L-bracket that can be formed using the single fiber composite described herein. For any of the calculations described herein, the apparatus 200 can include, for example, the L-bracket, a cantilever beam, or a 3-point bending example. However, the L-bracket, the cantilever beams, and the 3-point bending examples are illustrative examples that can be used to test physical properties of the specified design of the updated and optimized shape and fiber path of the continuous fiber composite. The apparatus 200 can be formed into any useful tools or other articles, such as can include: dental appliances; turbines for (e.g., for automotive, aerospace, or marine vehicle applications); medical devices; personal protective equipment; footwear; sporting goods; industrial equipment; packaging and construction materials; impellers; blades; energy storage devices; electronics; optical devices; and in oil and gas applications.

As illustrated in FIG. 2A-2D, the shape 210 and the orientation of the infilled fibers 212D can be updated as the level-set method on the fixed finite element completes iterations.

For example, the shape 210A of the apparatus 200A can still be the original L-bracket shape at 0 iterations of the level-set method. Further, the infilled fibers 212A of the apparatus 200A can be the original fiber orientations of the continuous fiber.

After 300 iterations, the shape 210B of the apparatus 200B can look very different than the shape 210A of the apparatus 200A. Moreover, the infilled fibers 212B of the apparatus 200B can also be optimized to improve the strength of the apparatus 200B when compared to the apparatus 200A.

After 500 iterations, the shape 210C of the apparatus 200C can continue to be optimized to limit stress concentrations within the apparatus 200C further when compared to apparatus 200A or apparatus 200B. Moreover, the infilled fibers 212C of the apparatus 200C can also be optimized to improve the strength of the apparatus 200C as compared to that of the apparatus 200A or the apparatus 200B.

After 600 iterations, the shape 210D of the apparatus 200D can continue to be optimized to limit stress concentrations within the apparatus 200D further when compared to the apparatus 200A, the apparatus 200B, or the apparatus 200C. Moreover, the infilled fibers 212D of the apparatus 200D can also be optimized to improve the strength of the apparatus 200D as compared to the apparatus 200A, the apparatus 200B, and the apparatus 200C.

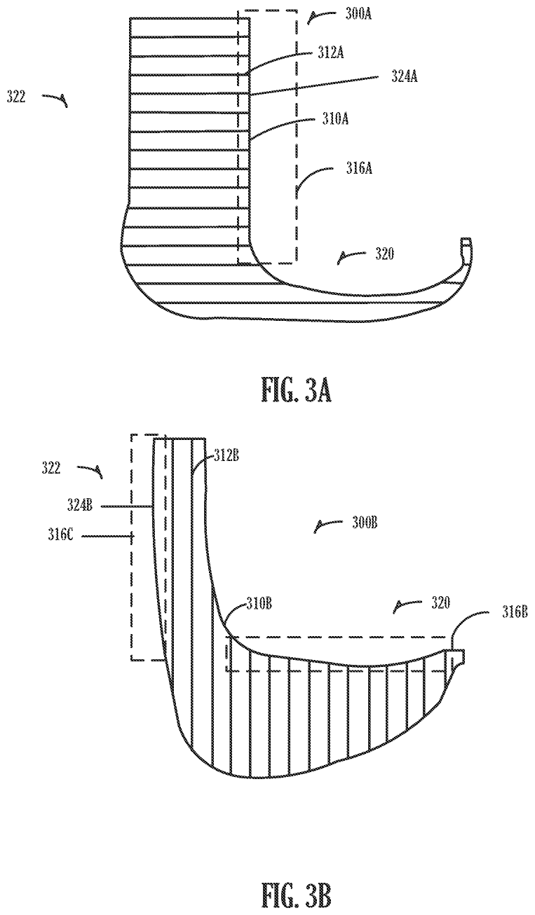

FIG. 3A illustrates a shape 310A with infilled fibers 312A of an apparatus 300A that can be optimized for maximizing strength with horizontal fibers. FIG. 3B illustrates a shape 310B with infilled fibers 312B of an apparatus 300B that can be optimized for maximizing strength with vertical fibers. FIGS. 3A and 3B will be discussed together below.

FIGS. 3A and 3B illustrate two examples with horizontal (FIG. 3A) and vertical (FIG. 3B) fiber directions (with respect to the page showing these FIGS.). The illustrative examples of FIGS. 3A and 3B show an example of the effect of fiber path optimization. The examples shown in both FIG. 3A and FIG. 3B used a volume fraction constraint of 0.5. The examples of FIGS. 3A and 3B used a fixed finite element mesh (e.g., discussed further with respect to FIG. 4A) and not an evolution method (e.g., the adapted mesh as discussed further with respect to FIG. 4B) because the fiber orientations are well-defined. Testing the samples shown in FIG. 3A and FIG. 3B demonstrated that the maximum failure index, or the maximum amount of stress that can be absorbed before failure of the example, can be increased significantly with one of horizontal or vertical fibers, as compared with an approach using concurrent topology and fiber path optimization.

For example, shape 310A of the apparatus 300A can have an increased horizontal thickness, which can be aligned with the infilled fibers 312A, as compared to the apparatus 300B. Similarly, the shape 310B of the apparatus 300B can have a greater vertical thickness, which can be aligned with the infilled fibers 312B, as compared to the apparatus 300A. Thus, because the horizontal and vertical fiber directions can improve the maximum failure index when compared with the design using concurrent topology and fiber path optimization, the fiber path orientation can be a factor in improving the strength of a single fiber composite and can help reduce the failure modes in the single fiber composite.

As also shown in FIG. 3A, the apparatus 300A can include a stress concentration 316A. As shown in FIG. 3A, the stress concentration 316A is primarily concentrated on or near a side or portion of the apparatus 300A that is closest to an extending portion 320. Further, the stress concentration 316A is located more on a side 324A of a portion of an upright portion 322 of apparatus 300A in FIG. 3A. As shown in FIG. 3B, the apparatus 300B can include a stress concentration 316B and a stress concentration 316C. The stress concentration 316B can be primarily concentrated on a side of the extending portion 320 that is closest to the upright portion 322. The stress concentration 316C can be primarily concentrated on or near a side 324B or portion of the upright portion 322 that is opposite the extending portion 320. Therefore, because the horizontal and vertical fiber directions can improve the maximum failure index when compared with the approach using concurrent topology and fiber path optimization and because the horizontal and vertical fiber directions can change the stress concentrations and the failure modes of the continuous fiber composites, the fiber path orientation can be a factor in improving the strength of a single fiber composite and can help reduce the failure modes in the single fiber composite.

FIGS. 4A and 4B illustrate an example of zero level-set isolines on fixed and evolutionary meshes, respectively. FIG. 4A illustrates a shape 410A on a fixed mesh 411A. FIG. 4B illustrates a shape 410B on a level-set based evolutionary mesh (e.g., an adapted mesh 411B). FIGS. 4A and 4B will be discussed together below, referring to their respective meshes 411. The meshes 411 can include mesh elements of one or various shapes, for example, triangle, quadrangle, tetrahedron, hexahedron, pentahedron, pyramid, or the like.

An example of the fixed mesh 411A is shown in FIG. 4A. During fixed finite element analysis, the apparatus 400A can include a mesh boundary 414A, which can be established to match the shape of the original apparatus (e.g., the shape 210A of the apparatus 200A). A shape 410A of the apparatus 400A can be completely contained within the established mesh boundary 414A. During finite element analysis iterations of the fixed mesh 411A, the mesh boundary 414A can be fixed-it need not change from a first update to a second update, for example, during operation 120 of the method 100 from FIG. 1. The fixed mesh 411A can be fixed at one or more nodes at locations of the body of the continuous fiber composite. The fixed mesh 411A can be configured to improve a shape and fiber path efficiently and effectively for the continuous fiber composite. In an example, all meshes of the fixed mesh 411A can be used in the finite element analysis calculations.

The example of the adapted mesh 411B, as shown in FIG. 4B, during evolutionary finite element analysis of the apparatus 400B, can include a mesh boundary 414B, which can match a shape 410B of the apparatus 400B. During iterations of the adapted mesh 411B, the mesh boundary 414B can evolve, adapt, or conform, to match the shape 410B of each iteration of the apparatus 400B. In an example, only the portion within a boundary of the shape 410B that can be discretized with the adapted mesh 411B need be used in the finite element analysis calculation. For example, the adapted mesh 411B can be used during operation 140 of the method 100 from FIG. 1.

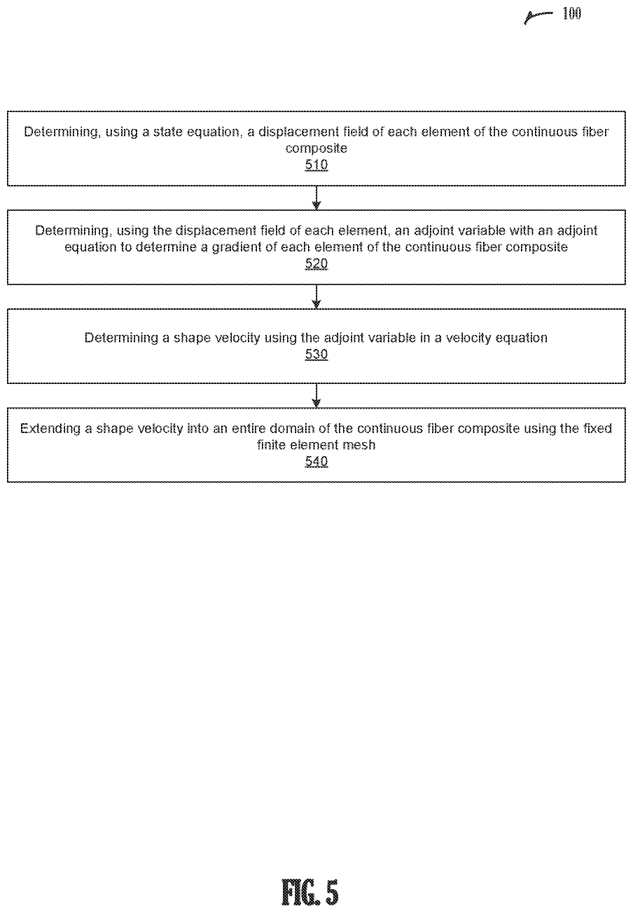

FIG. 5 is a flowchart that further describes an example of portions of the method 100. In the example of FIG. 5, the iterating updates of the shape and the fiber path using the fixed finite element mesh from operation 120 of the method 100 can optionally include steps 510-540. Steps 520-540 show examples of acts that can be used to extend the shape velocity more broadly, such as into the entire domain of the continuous fiber composite using the fixed finite element mesh.

At operation 510, operation 120 of the method 100 can be performed, such as can optionally include determining a displacement field of each element of the continuous fiber composite. For example, the displacement field of each element of the continuous fiber composite can be found using a fixed finite element mesh and one or more state equations (e.g., Equations 3 or 4). For example, the state equations can be solved, such as shown in Equations 5-19, such as to obtain Equations 20-24.

At operation 520, operation 120 of the method 100 can be performed, such as can optionally include determining an adjoint variable with an adjoint equation to determine a gradient of each element of the continuous fiber composite. For example, the finite element analysis can use the adjoint equation (e.g., Equation (17)) to obtain one or more adjoint variables.

At operation 530, operation 120 of the method 100 can be performed, such as can optionally include determining a shape velocity at a fiber orientation. The shape velocity can be used to find the shape derivative. For example, the shape velocity can be found using the adjoint variables found via the adjoint equation. For example, the finite element analysis can use the adjoint equation (e.g., Equation (17)) to obtain the shape derivative (e.g., Equation 18). As discussed herein, the terms of Equation (18) can be defined in Equation (19).

At operation 540, operation 120 of the method 100 can be performed, such as can optionally include extending a shape velocity further, such as into an entire domain of the continuous fiber composite. For example, the fixed finite element mesh can be used to extend the shape velocity into an entire domain of the continuous fiber composite. The finite element mesh can use Equation (25) to extend the shape velocity through the entire domain of the single fiber composite.

The level-set function of Equation (3) can be updated, such as using a step size Δt, reinitializing the level-set function of Equation (3) recurrently or periodically, finding a corresponding new shape and fiber paths, revising a skeleton fiber orientation. Then, a new objective can be calculated. For example, a new objective can find stress concentrations in the model, and if the stress concentrations are not reduced, the step size Δt can be decreased and Equation (3) can be updated. If the new objective is decreased, steps 510-540 can be repeated if the finite element analysis optimization has not converged.

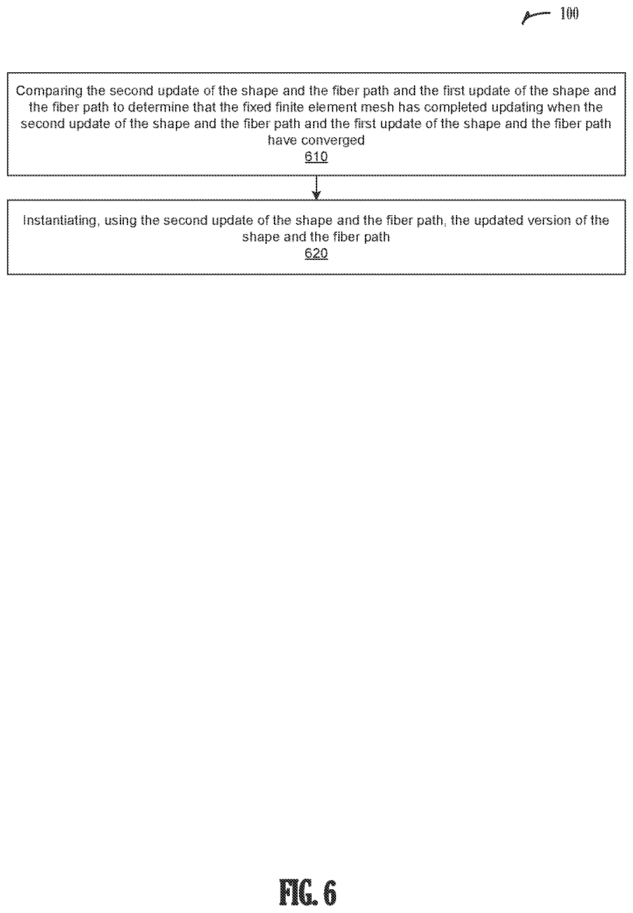

FIG. 6 is a flowchart that further describes an example of portions of the method 100. As described with respect to FIG. 6, iterating updates of the shape and the fiber path using the fixed finite element mesh of operation 120 of the method 100 can also include a first update of the shape and the fiber path and a second update of the shape and the fiber path. Operation 120 of the method 100 can optionally include steps 610 and 620. For example, the second update can be the most recent update, and the first update can be the immediately preceding update that was completed immediately before the second update.

At operation 610, the operation 120 of the method 100 can optionally include comparing the second update of the shape and the fiber path and the first update of the shape and the fiber path to determine whether the finite element has completed updated when the second update of the shape and the fiber path and the first update of the shape and the fiber path have converged. The finite element analysis can be completed with a fixed mesh.

At operation 620, the operation 120 of the method 100 can optionally include generating the updated version of the shape and the fiber path. The updated version of the shape and the fiber path can be generated using the second update of the shape and the fiber path. The second update can be used because it was the most recent update of the shape and the fiber path of the continuous fiber composite.

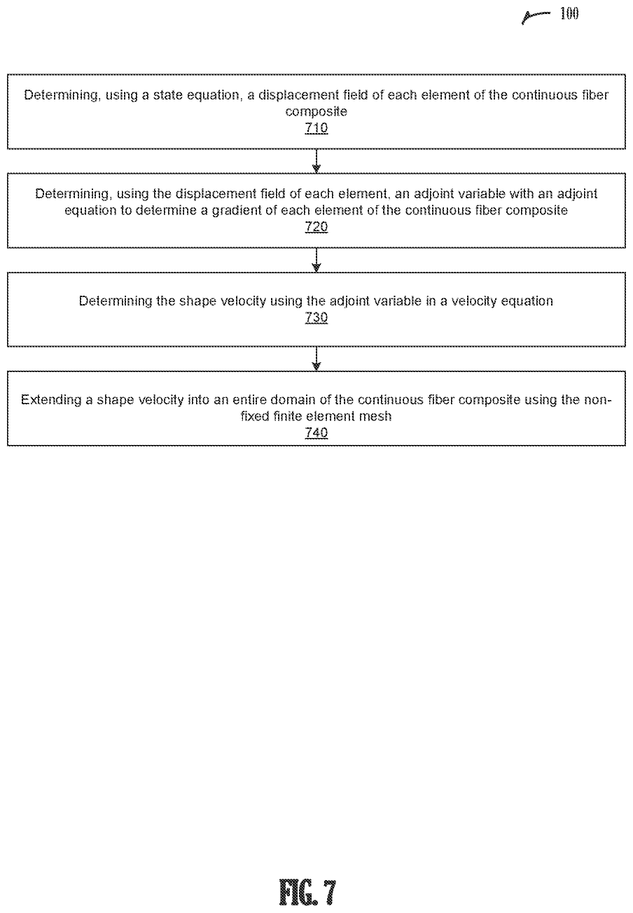

FIG. 7 is a flowchart that further describes an example of portions of the method 100, such as in which operation 140 of the method 100 can optionally include steps 710-740.

At operation 710, operation 140 of the method 100 can be performed, which can optionally include determining a displacement field of each element of the continuous fiber composite. The displacement field of each element of the continuous fiber composite can be found using an adapted finite element mesh and one or more state equations (e.g., Equations 3 or 4). For example, the state equations can be solved as shown in Equations 5-19 to obtain Equations 20-24.

At operation 720, operation 140 of the method 100 can be performed, such as to optionally include determining an adjoint variable with an adjoint equation to determine a gradient of each element of the continuous fiber composite. For example, the finite element analysis can use the adjoint equation (e.g., Equation (17)) to obtain one or more adjoint variables.

At operation 730, operation 140 of the method 100 can be performed, such as to optionally include determining a shape velocity. The shape velocity can be found using the adjoint variables found via the adjoint equation. The finite element analysis can use the adjoint equation (e.g., Equation (17)) to obtain the shape derivative (e.g., Equation 18). As discussed herein, the terms of Equation (18) can be defined in Equation (19).

At operation 740, operation 140 of the method 100 can be performed, such as can optionally include extending a shape velocity further, such as into an entire domain of the continuous fiber composite. The fixed finite element mesh can be used to extend the shape velocity into an entire domain of the continuous fiber composite. For example, the finite element mesh can use Equation (25) to extend the shape velocity through the entire domain of the single fiber composite.

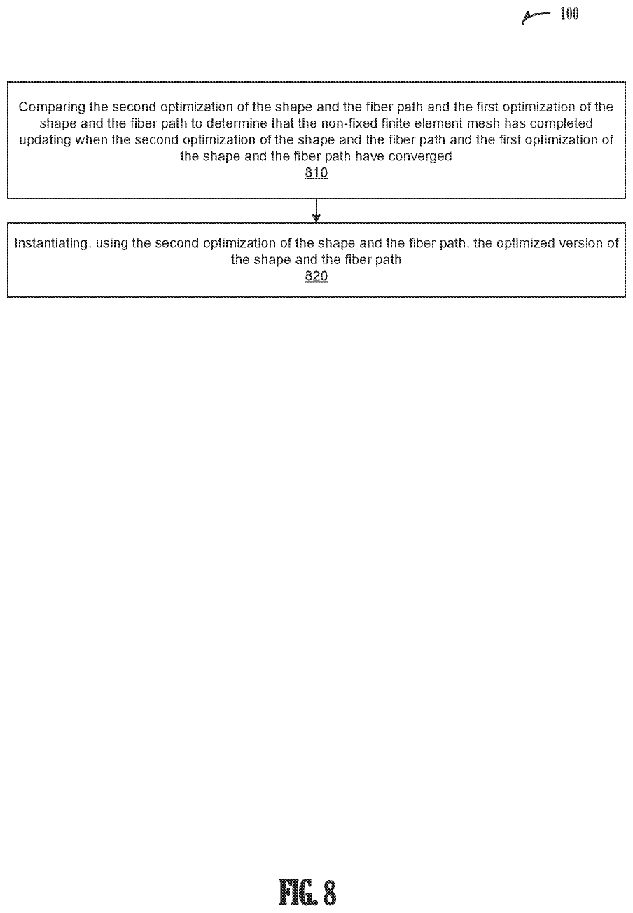

FIG. 8 is a flowchart that further describes an example of portions of the method 100. FIG. 8 shows an example of iterating updates of the shape and the fiber path using the adapted finite element mesh of operation 140 of the method 100. This can also include a first optimization of the shape and the fiber path and a second optimization of the shape and the fiber path. For example, the operation 140 of the method 100 can include steps 810 and 820. The second optimization can be the most recent optimization and the first optimization can be the optimization that was completed immediately before the second optimization.

At operation 810, the operation 140 of the method 100 can be performed, such as can optionally include comparing the second optimization of the shape and the fiber path and the first optimization of the shape and the fiber path to determine whether the finite element has completed optimizing when the second optimization of the shape and the fiber path and the first optimization of the shape and the fiber path have converged. The finite element analysis or optimization can be completed with an adapted mesh.

At operation 820, the operation 140 of the method 100 can be performed, such as can optionally include generating the optimized version of the shape and the fiber path. In examples, the optimized version of the shape and the fiber path can be generated using the second optimization of the shape and the fiber path. The second optimization can be used because it was the most recent optimization of the shape and the fiber path of the continuous fiber composite.

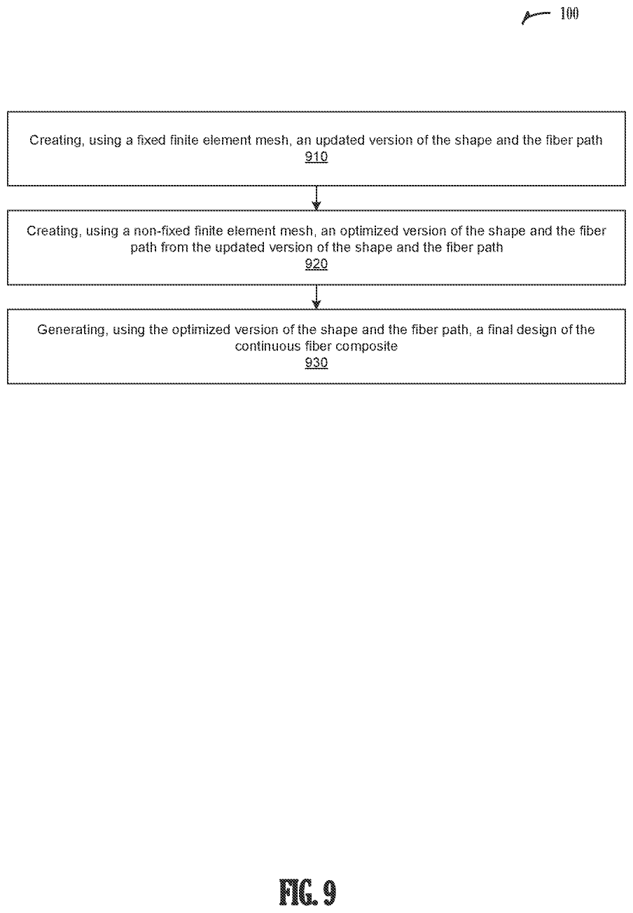

FIG. 9 is a flowchart that describes an example of portions of a method 600. The method 600 can include optimizing a shape and a fiber path for a continuous fiber composite.

At operation 910, the method can include creating, using a fixed finite element mesh, an updated version of the shape and the fiber path.

At operation 920, the method can include creating, using an adapted finite element mesh, an optimized version of the shape and the fiber path from the updated version of the shape and the fiber path.

At operation 930, the method can include generating, using the optimized version of the shape and the fiber path, a final arrangement of the continuous fiber composite. The method 600 can also include any of the method steps discussed with respect to FIGS. 1, and FIGS. 5-8.

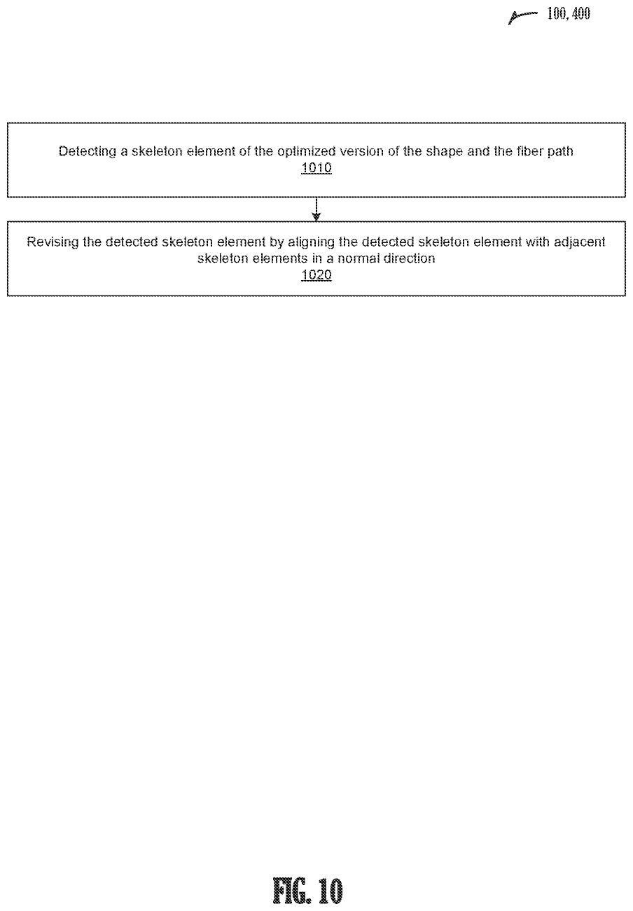

FIG. 10 is a flowchart that further describes an example of portions of the method of optimizing a shape and a fiber path for a continuous fiber composite from FIG. 1. For example, either of the method 100 or the method 600 can be employed and can further improve their results by implementing steps 1010 and 1020.

At operation 1010, the method 100 or the method 600 can also include detecting a skeleton element of the optimized version of the shape and the fiber path of the continuous fiber composite. At operation 1020, the method 100 or the method 600 can also include revising the detected skeleton element such as by aligning the detected skeleton element with adjacent skeleton elements in a normal direction aligned with the other skeleton elements.

A failure index singularity can be found, such as using the following example functions. An element orientation angle θ can be determined using Eq. (4) through a derivative of nodal level-set value ϕ. This definition usually will not cause any issue, except possibly on the shape skeleton. A discontinuity can occur in the derivative of the level-set function on the skeleton. This can lead to discontinuity of the fiber orientations, thus can result in a failure index singularity on the skeleton. These singularities can be classified into two categories, fixable and unfixable, such as illustrated below.

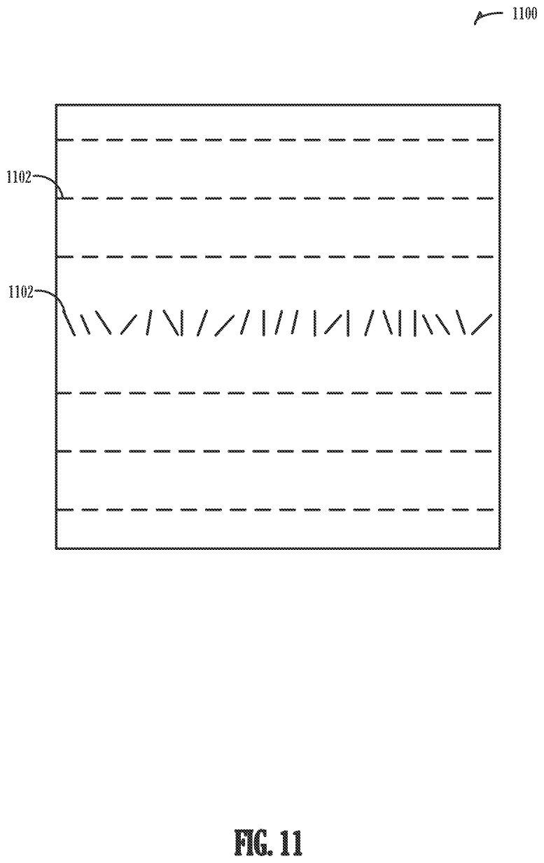

FIG. 11 illustrates an example of fiber orientations 1102 of an apparatus 1100 with random orientations in the middle of the apparatus 1100. The random orientations of the fibers in the middle of the continuous fiber composite sample can be discovered using Eq. (4). The random orientation in the middle can occur because both dϕ/dx and dϕ/dy are close to 0 on the skeleton. The element orientation angles, θ, may not be well defined from Eq. (4). This can lead to randomly distributed fiber orientations on the skeleton.

Each skeleton fiber orientation can be revised to that of an adjacent element of each respective skeleton fiber orientation.

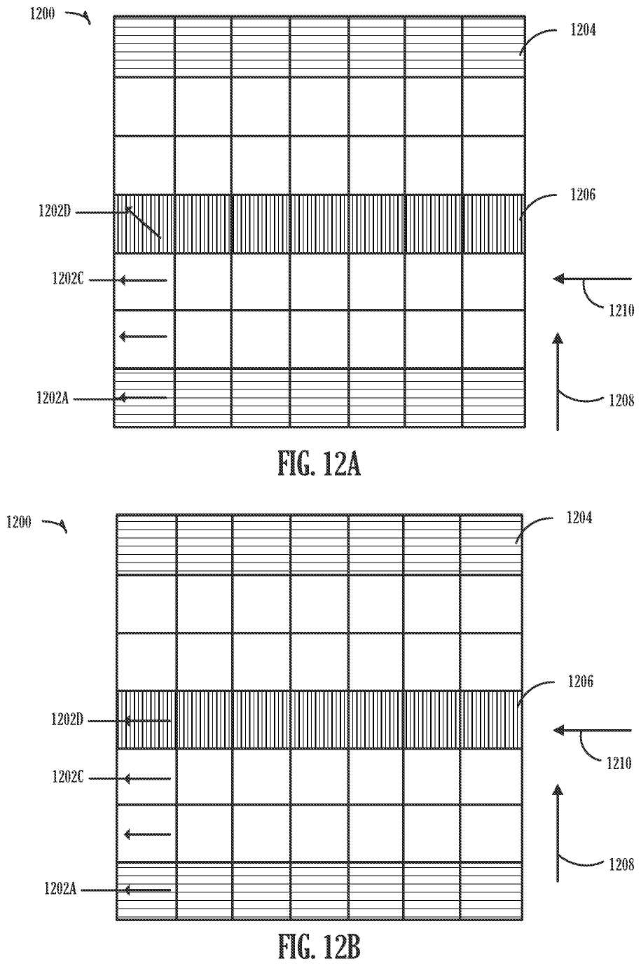

FIG. 12A illustrates a schematic of a plate with fiber orientations before revision. FIG. 12B illustrates a schematic of a plate with fiber orientations after revision. FIGS. 12A and 12B will be discussed concurrently herein. As shown in FIGS. 12A and 12B, a sparse mesh can use a signed distance function distribution. The boundary elements 1204 of the mesh can be marked with horizontal lines. Skeleton elements 1206 of the mesh can be marked with vertical lines.

FIG. 12A also shows an example of the selected element index and their fiber orientations 1202, which are denoted as arrows along the first searching direction 1208. In a first step, each element along the boundary travels through the normal direction 1210 into the rigid, finds the entering and exiting point of each mesh element, and targets the skeleton element if the following criterion is met:

$$\vert \frac{ϕ ( {𝓏}_{1} ) - ϕ ( {𝓏}_{0} )}{‖ {𝓏}_{1} - {𝓏}_{0} ‖} - sign ( ϕ ( {𝓏}_{0} ) ) \vert \geq 0.3 \qquad ( 29 )$$

where z₀, z₁ can represent an entering and exiting point of the search in an element, and ϕ can be the signed distance function.

For example, as shown in FIG. 12A, start from element 1202A, travel along the normal direction (upward on the page) of the boundary (lowest horizontal line in FIG. 12A), record the entering and exiting point of each element, and identify a corresponding skeleton element 1202D when Eq. (29) is satisfied. FIG. 12B illustrates a second operation in which the detected skeleton fiber orientation can be revised to match that of one or more adjacent elements in the normal direction 1210. For example, as shown in FIG. 12B, the fiber orientation of skeleton element 1202D can be revised to that of adjacent element 1202C shown just below the skeleton element 1202D on the page. This two-operation process can continue until all boundary elements are traveled through, leading to a complete search and orientation revision for skeleton elements.

In an example, an apparatus can be simulated using a 3-point bending problem, which can be simplified (using symmetry) into a half model. The applied loading can be 3 KN for this half model and the targeted volume fraction can be 0.3. The level-set method with fixed mesh can be used for the optimization in a first stage.

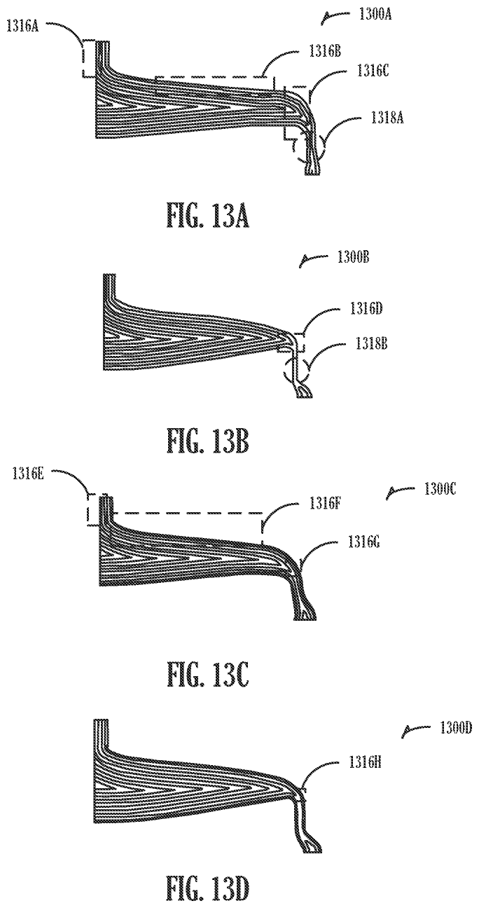

FIG. 13A illustrates a shape with infilled fibers of a 3-point bending example that can be optimized for failure index minimization using a level-set method on fixed mesh. FIG. 13B illustrates a shape with infilled fibers of a 3-point bending example that uses a level-set method on fixed mesh. FIGS. 13A and 13B will be discussed together below.

In FIG. 13A, an apparatus 1300A can include a stress concentration 1316A, stress concentration 1316B, stress concentration 1316C, and a thin portion 1318A. The stress concentration 1316A can be in the top left portion of the apparatus 1300A. The stress concentration 1316B can extend along a top surface of the apparatus 1300A. The stress concentration 1316C can extend in the end of the apparatus 1300A, which is on the opposite end of the apparatus 1300A from the stress concentration 1316A. The thin portion 1318A can extend from the end of the apparatus 1300A nearest the stress concentration 1316C.

In FIG. 13B, an apparatus 1300B can include a stress concentration 1316D and a thin portion 1318B. In FIG. 13B, the level-set method using a fixed finite element mesh can help reduce the stress concentrations in the apparatus 1300B as compared to apparatus 1300A. The stress concentration 1316D can be located near the end of the apparatus 1300B, similar to the location of stress concentration 1316C of the apparatus 1300A. The thin portion 1318B can extend from the end of the apparatus 1300B nearest the stress concentration 1316D. As compared to the thin portion 1318A in the apparatus 1300A, the thin portion 1318B of apparatus 1300B seems to be thinner, which can reduce a strength of the thin portion 1318B of the apparatus 1300B as compared to the thin portion 1318A of the apparatus 1300A.

Similar to the previous examples, the failure index distribution for the strength-based approach (FIG. 13A) can be more uniform than that of the compliance-based approach (FIG. 13B), leading to a lower maximum value and a more efficient load bearing. The examples in FIGS. 13A and 13B can present two issues. First, unsmooth boundaries can exist with local failure index perturbation due to the use of fixed finite element mesh. Second, the vertical supporting bars on the bottom right side in both designs (e.g., the thin portion 1318A and thin portion 1318B) can be too thin for manufacturing.

To help further improve the continuous fiber composite, a thickness control can be implemented. For example, to avoid an over-thin section, a thickness control scheme can be implemented in the optimization process. A few methods have been developed in the level-set framework for this purpose. For example, a feature-based structural topology optimization method can be used. As another example, a method can include a quadratic energy component in an objective function to introduce non-trivial interactions between different points on the structural boundary. This can lead to a family of shapes with strip-like (or beam-like) features. In yet another example, a method can include achieving an explicit feature control of the optimal topology by imposing one or more constraints on the extreme values of the signed distance function used to describe the structure's topology. These approaches may have difficulty defining a thickness or a minimum feature size. Thus, instead of implementing a precise minimum feature size, a penalty function can be added in an objective function to avoid over-thin members:

P_{MinT}(Ω)=∫_{Ω}j(d_{Ω})dx (30)

with

j(d_{Ω})=−d_{Ω}²max(d_{Ω}+dₘᵢₙ/2,0)² (31)

where d_{Ω} can be the signed distance function and dₘᵢₙ can be a minimum thickness to target. A shape derivative of this penalty term can have the following form:

P′_{MinT}(Ω)=∫_{Ω}j′(d_{Ω})d′_{Ω}dx (32)

with

j′(d_{Ω})=−2[d_{Ω}max(d_{Ω}+dₘᵢₙ/2,0)²+d_{Ω}²max(d_{Ω}+dₘᵢₙ/2,0)] (33)

Using a co-area formula, the volume integral in Eq. (32) can be decomposed into a surface integral along the shape boundary and an integral along the ray emerging from it, leading to:

P′_{MinTE}(Ω)(θ)=∫_{∂Ω}∫_{s∈ray(x)∩Ω}d′_{Ω}(s)(θ)j′(d_{Ω}(s))(1+d_{Ω}(s)κ(x))dsdx (34)

where κ(x) can be the curvature of level-set function. d′_{Ω}(s)(θ) can be moved out of the second integral since it can be constant along the rays, and its expression on the boundary can read:

d′_{Ω}(θ)(x)=−θ(x)·n(x),∀x∈∂Ω (35)

Thus P′_{MinTE}(Ω)(θ) can be further written as:

P′_{MinTE}(Ω)(θ)=−∫_{∂Ω}[∫_{s∈ray(x)∩Ω}j′(d_{Ω}(s))(1+d_{Ω}(s)κ(x))]θ(x)·n(x)dx (36)

From Eq. (36), a thickness related velocity term, g_{T}, defined on ∂Ω can be obtained as follows:

g_{T}(x)=∫_{s∈ray(x)∩Ω}j′(d_{Ω}(s)κ(x))∀x∈∂Ω (37)

The above term can be added to Eq. (191) for velocity revision.

To conduct an integral of the right-hand side of Eq. (37), a variational formulation for computing shape derivatives of geometric constraints along rays can be used. A solution, u, of a variational problem Eq. (38) on the shape boundary an, can give g_{T} in Eq. (35):

∫_{∂Ω}uvdx+∫_{D\Σ̅}∫(∇d_{Ω}·∇u)(∇d_{Ω}·∇v)dA=∫_{D\Σ̅}j′(d_{Ω})vdA (38)

where Σ̅ can be a disclosure of skeleton and c can be a weight. Furthermore, by appropriately choosing the weight, ω, so that it takes very small values near a skeleton Σ̅, and consequently revising Eq. (38) by using integral region of D instead of D/Σ̅ in a second and third integral, an accurate approximation of u can be obtained, which can be the value of g_{T} in Eq. (37).

A penalty term can be included in a second stage, the updated optimization problem is stated as:

minimize γ(Ω)+l_{E}P_{minT}(Ω)

subject to a(u,v)=l(v)

V≤Vₘₐₓ (39)

where l_{E} can be a weight coefficient for penalty term. Note that the penalty term related to thickness control may be unnecessary unless the optimized design includes over-thin geometric features.

In a second optimization stage, a level-set-based mesh evolution method can be used to resolve these problems. A thickness penalty term can also be included in the objective function. A parameter dₘᵢₙ=0.1 can be used in the thickness control term. Note that this is merely a penalty term in the objective function to avoid over-thin in-plane thickness of members but does not guarantee a minimum thickness of dₘᵢₙ.

FIG. 13C is a shape with infilled fibers of a 3-point bending example optimized for failure index minimization with thickness control. FIG. 13D is a shape with infilled fibers of a 3-point bending example that can be optimized for compliance minimization with thickness control. FIGS. 13C and 13D will be discussed together below with reference to FIGS. 13A and 13B.

As shown in FIG. 13C, an apparatus 1300C can include a stress concentration 1316E, stress concentration 1316F, and stress concentration 1316G. As shown in FIG. 13C, the thickness penalty can completely remove the thin portions from apparatus 1300A and apparatus 1300B. However, the stress concentration 1316E appears near the same location of the stress concentration 1316A in the apparatus 1300A, stress concentration 1316F appears near the same location of the stress concentration 1316B in the apparatus 1300A, and the stress concentration 1316G appears near the same location of the stress concentration 1316C of the apparatus 1300A. The magnitude of the stress concentration 1316E, the stress concentration 1316F, and the stress concentration 1316G can be reduced when compared to the stress concentration 1316A, the stress concentration 1316B, and the stress concentration 1316C, respectively.

As shown in FIG. 13D, an apparatus 1300D can include a stress concentration 1316H. As shown in FIG. 13D, optimizing the apparatus 1300D for compliance minimization, for example, with a fixed or an adapted finite element mesh, while implementing a thickness penalty, can help reduce stress concentrations and thin portions of the apparatus 1300D when compared to the apparatus 1300A, the apparatus 1300B, and the apparatus 1300C. The stress concentration 1316H can be located near the same location of the stress concentration 1316G and the stress concentration 1316C, but can have lower magnitude as compared to the stress concentration 1316G and the stress concentration 1316C.

As discussed above, FIG. 13C illustrates a new optimized example for a strength-based approach and FIG. 13D illustrates a new optimized example for the compliance-based approach. As shown in FIGS. 13C and 13D, a thickness of the vertical supporting bars has increased significantly in both cases, which improves their manufacturability.

At the final stage, a maximum failure index of the strength-based example (of FIG. 13C) can be half of the compliance-based example (shown in 13D), while the compliance of the strength-based example (shown in FIG. 13A) (0.689 N·mm) can be 36% higher than that of the compliance-based example (shown in FIG. 13B) (0.506 N·mm).

In conclusion, a novel framework for a strength-based concurrent shape and fiber path optimization of continuous fiber-reinforced composites is described herein. The level-set method can be employed to optimize both material distribution and fiber paths. A combination of level-set methods on fixed and evolutionary meshes can be implemented to efficiently obtain optimized designs with smooth shape boundary free of failure index perturbation. A skeleton fiber orientation operation can be developed to eliminate the failure index singularity on shape skeletons to the largest extent. Thickness control can be employed when the design involves components with over-thin in-plane thickness.

Three numerical examples of an apparatus are discussed herein to evaluate the effectiveness of the developed algorithm. However, the apparatus can be made of any example, not just the three illustrative examples. The strength-based approach was compared with the compliance-based approach in all three cases. It was shown that the strength-based approach distributed the failure index more uniformly thus the strength-based approach can effectively reduce the failure index concentrations. It was also demonstrated through the L-bracket example that optimizing the fiber path via the level-set method can further enhance the structural strength compared with straight fibers, justifying the necessity of concurrent shape and fiber paths optimization. Failure index singularities around the members' skeleton can be reduced or eliminated such as by incorporating the skeleton fiber orientation revision step. This can lead to a more accurate local failure index field, as demonstrated in L-bracket and cantilever beam examples. In all three examples, the optimization was conducted in two stages. The first stage employed the level-set method on fixed mesh to obtain the optimized result, followed by the second stage using the level-set-based mesh evolution method. This two-stage approach can result in a smooth boundary free of failure index concentrations due to the accurate shape discretization. Furthermore, since the optimized example of the 3-point bending contained excessively thin bar components, the thickness control term was introduced to the objective function to enlarge the bar thickness for manufacturability. In summary, the developed method can be an efficient tool for concurrent strength-based shape and fiber path optimization of continuous fiber-reinforced composites, capable of providing satisfactory local failure index distributions while ensuring manufacturability.

As described herein, a computer-implemented method of optimizing a computer model including a shape and a fiber path for a continuous fiber composite can be used to find a specified design of a model of a continuous fiber composite. The specified design of the model can be used to manufacture an apparatus using the specified design. For example, the specified design can be ran by an additive manufacturing machine, a lamination machine, or any other device that can be used to manufacture continuous fiber composites, to create an apparatus, device, assembly, or other use of the specified design of the continuous fiber composite.

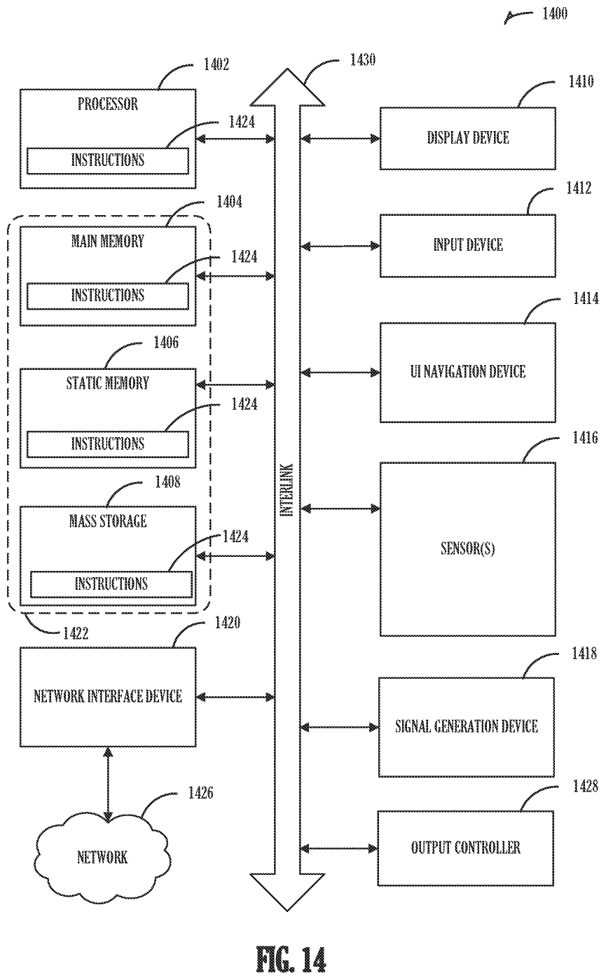

FIG. 14 illustrates a block diagram of implemented an example machine 1400 upon which any one or more of the techniques (e.g., methodologies) discussed herein may perform. Examples, as described herein, may include, or may operate by, logic or a number of components, or mechanisms in the machine 1400. Circuitry (e.g., processing circuitry) is a collection of circuits implemented in tangible entities of the machine 1400 that include hardware (e.g., simple circuits, gates, logic, etc.). Circuitry membership may be flexible over time. Circuitries include members that may, alone or in combination, perform specified operations when operating. In an example, hardware of the circuitry may be immutably designed to carry out a specific operation (e.g., hardwired). In an example, the hardware of the circuitry may include variably connected physical components (e.g., execution units, transistors, simple circuits, etc.) including a machine readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuitry in hardware via the variable connections to carry out portions of the specific operation when in operation. Accordingly, in an example, the machine readable medium elements are part of the circuitry or are communicatively coupled to the other components of the circuitry when the device is operating. In an example, any of the physical components may be used in more than one member of more than one circuitry. For example, under operation, execution units may be used in a first circuit of a first circuitry at one point in time and reused by a second circuit in the first circuitry, or by a third circuit in a second circuitry at a different time. Additional examples of these components with respect to the machine 1400 follow.

In alternative embodiments, the machine 1400 may operate as a standalone device or may be connected (e.g., networked) to other machines. In a networked deployment, the machine 1400 may operate in the capacity of a server machine, a client machine, or both in server-client network environments. In an example, the machine 1400 may act as a peer machine in peer-to-peer (P2P) (or other distributed) network environment. The machine 1400 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

The machine (e.g., computer system) 1400 may include a hardware processor 1402 (e.g., a central processing unit (CPU), a graphics processing unit (GPU), a hardware processor core, or any combination thereof), a main memory 1404, a static memory (e.g., memory or storage for firmware, microcode, a basic-input-output (BIOS), unified extensible firmware interface (UEFI), etc.) 1406, and mass storage 1408 (e.g., hard drives, tape drives, flash storage, or other block devices) some or all of which may communicate with each other via an interlink (e.g., bus) 1430. The machine 1400 may further include a display unit 1410, an alphanumeric input device 1412 (e.g., a keyboard), and a user interface (UI) navigation device 1414 (e.g., a mouse). In an example, the display unit 1410, input device 1412 and UI navigation device 1414 may be a touch screen display. The machine 1400 may additionally include a storage device (e.g., drive unit) 1408, a signal generation device 1418 (e.g., a speaker), a network interface device 1420, and one or more sensors 1416, such as a global positioning system (GPS) sensor, compass, accelerometer, or other sensor. The machine 1400 may include an output controller 1428, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

Registers of the processor 1402, the main memory 1404, the static memory 1406, or the mass storage 1408 may be, or include, a machine readable medium 1422 on which is stored one or more sets of data structures or instructions 1424 (e.g., software) embodying or utilized by any one or more of the techniques or functions described herein. The instructions 1424 may also reside, completely or at least partially, within any of registers of the processor 1402, the main memory 1404, the static memory 1406, or the mass storage 1408 during execution thereof by the machine 1400. In an example, one or any combination of the hardware processor 1402, the main memory 1404, the static memory 1406, or the mass storage 1408 may constitute the machine readable media 1422. While the machine readable medium 1422 is illustrated as a single medium, the term “machine readable medium” may include a single medium or multiple media (e.g., a centralized or distributed database, and/or associated caches and servers) configured to store the one or more instructions 1424.

The term “machine readable medium” may include any medium that is capable of storing, encoding, or carrying instructions for execution by the machine 1400 and that cause the machine 1400 to perform any one or more of the techniques of the present disclosure, or that is capable of storing, encoding or carrying data structures used by or associated with such instructions. Non-limiting machine readable medium examples may include solid-state memories, optical media, magnetic media, and signals (e.g., radio frequency signals, other photon based signals, sound signals, etc.). In an example, a non-transitory machine readable medium comprises a machine readable medium with a plurality of particles having invariant (e.g., rest) mass, and thus are compositions of matter. Accordingly, non-transitory machine-readable media are machine readable media that do not include transitory propagating signals. Specific examples of non-transitory machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

In an example, information stored or otherwise provided on the machine readable medium 1422 may be representative of the instructions 1424, such as instructions 1424 themselves or a format from which the instructions 1424 may be derived. This format from which the instructions 1424 may be derived may include source code, encoded instructions (e.g., in compressed or encrypted form), packaged instructions (e.g., split into multiple packages), or the like. The information representative of the instructions 1424 in the machine readable medium 1422 may be processed by processing circuitry into the instructions to implement any of the operations discussed herein. For example, deriving the instructions 1424 from the information (e.g., processing by the processing circuitry) may include: compiling (e.g., from source code, object code, etc.), interpreting, loading, organizing (e.g., dynamically or statically linking), encoding, decoding, encrypting, unencrypting, packaging, unpackaging, or otherwise manipulating the information into the instructions 1424.

In an example, the derivation of the instructions 1424 may include assembly, compilation, or interpretation of the information (e.g., by the processing circuitry) to create the instructions 1424 from some intermediate or preprocessed format provided by the machine readable medium 1422. The information, when provided in multiple parts, may be combined, unpacked, and modified to create the instructions 1424. For example, the information may be in multiple compressed source code packages (or object code, or binary executable code, etc.) on one or several remote servers. The source code packages may be encrypted when in transit over a network and decrypted, uncompressed, assembled (e.g., linked) if necessary, and compiled or interpreted (e.g., into a library, stand-alone executable etc.) at a local machine, and executed by the local machine.

The instructions 1424 may be further transmitted or received over a communications network 1426 using a transmission medium via the network interface device 1420 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), LoRa/LoRaWAN, or satellite communication networks, mobile telephone networks (e.g., cellular networks such as those complying with 3G, 4G LTE/LTE-A, or 5G standards), Plain Old Telephone (POTS) networks, and wireless data networks (e.g., Institute of Electrical and Electronics Engineers (IEEE) 502.11 family of standards known as Wi-Fi®, IEEE 502.15.4 family of standards, peer-to-peer (P2P) networks, among others. In an example, the network interface device 1420 may include one or more physical jacks (e.g., Ethernet, coaxial, or phone jacks) or one or more antennas to connect to the communications network 1426. In an example, the network interface device 1420 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 1400, and includes digital or analog communications signals or other intangible medium to facilitate communication of such software. A transmission medium is a machine readable medium.

The following, non-limiting examples, detail certain aspects of the present subject matter to solve the challenges and provide the benefits discussed herein, among others.

Example 1 is a computer-implemented method of optimizing a computer model including a shape and a fiber path for a continuous fiber composite, the method comprising: initializing a fixed finite element mesh; creating an updated version of the shape and the fiber path by iterating updates of the shape and the fiber path using the fixed finite element mesh; initializing an adapted finite element mesh on the updated version of the shape and the fiber path; creating an optimized version of the shape and the fiber path by iterating optimizations of the shape and the fiber path using the adapted finite element mesh; and generating, using the optimized version of the shape and the fiber path, a specified design of the continuous fiber composite.

In Example 2, the subject matter of Example 1 includes, wherein the fixed finite element mesh includes a first set of material properties, and a first set of optimization parameters, wherein the adapted finite element mesh includes a second set of material properties that include a second property value that is variable from a first property value from the first set of material properties, and wherein the adapted finite element mesh includes a second set of optimization parameters includes a second optimization value that is variable from a first optimization value of the first set of optimization parameters.

In Example 3, the subject matter of Examples 1-2 includes, wherein the fixed finite element mesh includes a first set of material properties and a first set of optimization parameters.

In Example 4, the subject matter of Example 3 includes, wherein the adapted finite element mesh includes the first set of material properties and the first set of optimization parameters.

In Example 5, the subject matter of Examples 1-4 includes, wherein iterating updates of the shape and the fiber path using the fixed finite element mesh comprises: extending a shape velocity into a larger domain of the continuous fiber composite using the fixed finite element mesh.

In Example 6, the subject matter of Example 5 includes, wherein extending the shape velocity into the entire domain of the continuous fiber composite using the fixed finite element mesh comprises: determining a displacement field of each element of the continuous fiber composite; determining, using the displacement field of each element, an adjoint variable to determine a gradient of each element of the continuous fiber composite; and determining the shape velocity using the adjoint variable.

In Example 7, the subject matter of Examples 1-6 includes, wherein iterating updates of the shape and the fiber path using the fixed finite element mesh comprises: a first update of the shape and the fiber path; and a second update of the shape and the fiber path.

In Example 8, the subject matter of Example 7 includes, wherein creating an updated version of the shape and the fiber path when iterating the updates is complete comprises: comparing the second update of the shape and the fiber path and the first update of the shape and the fiber path to determine that the fixed finite element mesh has completed updating when the second update of the shape and the fiber path and the first update of the shape and the fiber path have converged; and instantiating, using the second update of the shape and the fiber path, the updated version of the shape and the fiber path.

In Example 9, the subject matter of Examples 1-8 includes, wherein iterating optimizations of the shape and the fiber path using the adapted finite element mesh comprises: a first optimization of the shape and the fiber path; and a second optimization of the shape and the fiber path.

In Example 10, the subject matter of Example 9 includes, wherein creating an optimized version of the shape and the fiber path when iterating the optimizations is complete comprises: comparing the second optimization of the shape and the fiber path and the first optimization of the shape and the fiber path to determine that the adapted finite element mesh has completed updating when the second optimization of the shape and the fiber path and the first optimization of the shape and the fiber path have converged; and instantiating, using the second optimization of the shape and the fiber path, the optimized version of the shape and the fiber path.

In Example 11, the subject matter of Examples 1-10 includes, wherein iterating optimizations of the shape and the fiber path using the adapted finite element mesh comprises: extending a shape velocity into an entire domain of the continuous fiber composite using the adapted finite element mesh.

In Example 12, the subject matter of Example 11 includes, wherein extending the shape velocity into the entire domain using the adapted finite element mesh comprises: determining, using a state equation, a displacement field of each element of the continuous fiber composite; determining, using the displacement field of each element, an adjoint variable with an adjoint equation to determine a gradient of each element of the continuous fiber composite; and determining the shape velocity using the adjoint variable in a velocity equation.

In Example 13, the subject matter of Examples 1-12 includes, wherein generating, using the optimized version of the shape and the fiber path, a specified design of the continuous fiber composite comprises: detecting a skeleton element of the optimized version of the shape and the fiber path; and revising the detected skeleton element by aligning the detected skeleton element with adjacent skeleton elements in a normal direction.

In Example 14, the subject matter of Examples 1-13 includes, wherein the adapted finite element mesh includes a thickness penalty term, the thickness penalty term to implement a thickness control of the continuous fiber composite.

Example 15 is a method of optimizing a shape and a fiber path for a continuous fiber composite, the method comprising: creating, using a fixed finite element mesh, an updated version of the shape and the fiber path; creating, using a adapted finite element mesh, an optimized version of the shape and the fiber path from the updated version of the shape and the fiber path; and generating, using the optimized version of the shape and the fiber path, a specified design of the continuous fiber composite.

In Example 16, the subject matter of Example 15 includes, wherein creating, with a fixed finite element mesh, an updated version of the shape and the fiber path comprises: generating a first update of the shape and the fiber path; generating a second update of the shape and the fiber path; comparing the second update of the shape and the fiber path and the first update of the shape and the fiber path to determine that the fixed finite element mesh has completed updating when the second update of the shape and the fiber path and the first update of the shape and the fiber path have converged; and instantiating, using the second update of the shape and the fiber path, an updated version of the shape and the fiber path.

In Example 17, the subject matter of Example 16 includes, wherein generating a first update of the shape and the fiber path and generating a second update of the shape and the fiber path comprises: determining, using a state equation, a displacement field of each element of the continuous fiber composite; determining, using the displacement field of each element, an adjoint variable with an adjoint equation to determine a gradient of each element of the continuous fiber composite; determining a shape velocity using the adjoint variable in a shape velocity equation; and extending the shape velocity into an entire domain of the continuous fiber composite using the fixed finite element mesh.

In Example 18, the subject matter of Examples 15-17 includes, wherein creating, with a adapted finite element mesh, an optimized version of the shape and the fiber path from the updated version of the shape and the fiber path comprises: generating a first optimization of the shape and the fiber path; generating a second optimization of the shape and the fiber path; comparing the second optimization of the shape and the fiber path and the first optimization of the shape and the fiber path to determine that the adapted finite element mesh has completed updating when the second optimization of the shape and the fiber path and the first optimization of the shape and the fiber path have converged; and instantiating, using the second optimization of the shape and the fiber path, an optimized version of the shape and the fiber path.

In Example 19, the subject matter of Example 18 includes, wherein generating a first optimization of the shape and the fiber path and generating a second optimization of the shape and the fiber path comprises: determining, using a state equation, a displacement field of each element of the continuous fiber composite; determining, using the displacement field of each element, an adjoint variable with an adjoint equation to determine a gradient of each element of the continuous fiber composite; determining a shape velocity using the adjoint variable in a velocity equation; and extending the shape velocity into an entire domain of the continuous fiber composite using the adapted finite element mesh.

Example 20 is an apparatus or article of manufacture optimized using the method of Example 15.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

Example 25 is a system, apparatus, or a method to implement any element of any of Examples 1-20.

The above-detailed description includes references to the accompanying drawings, which form a part of the detailed description. The drawings show, by way of illustration, specific embodiments in which the invention can be practiced. These embodiments are also referred to generally as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following aspects, the terms “including” and “comprising” are open-ended, that is, a system, device, article, composition, formulation, or process that includes elements in addition to those listed after such a term in a claim are still deemed to fall within the scope of that claim. Moreover, in the following aspects, the terms “first,” “second,” and “third,” etc. are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Such instructions can be read and executed by one or more processors to enable performance of operations comprising a method, for example. The instructions are in any suitable form, such as but not limited to source code, compiled code, interpreted code, executable code, static code, dynamic code, and the like.

Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like. The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following aspects are hereby incorporated into the Detailed Description as examples or embodiments, with each aspect standing on its own as a separate embodiment, and it is contemplated that such embodiments can be combined with each other in various combinations or permutations.

1. A computer-implemented method of optimizing a computer model including a shape and a fiber path for a continuous fiber composite, the method comprising:
initializing a fixed finite element mesh;
creating an updated version of the shape and the fiber path by iterating updates of the shape and the fiber path using the fixed finite element mesh;
initializing an adapted finite element mesh on the updated version of the shape and the fiber path;
creating an optimized version of the shape and the fiber path by iterating optimizations of the shape and the fiber path using the adapted finite element mesh; and
generating, using the optimized version of the shape and the fiber path, a specified design of the continuous fiber composite.

2. The method of claim 1, wherein the fixed finite element mesh includes a first set of material properties, and a first set of optimization parameters, wherein the adapted finite element mesh includes a second set of material properties that include a second property value that is variable from a first property value from the first set of material properties, and wherein the adapted finite element mesh includes a second set of optimization parameters includes a second optimization value that is variable from a first optimization value of the first set of optimization parameters.

3. The method of claim 1, wherein the fixed finite element mesh includes a first set of material properties and a first set of optimization parameters.

4. The method of claim 3, wherein the adapted finite element mesh includes the first set of material properties and the first set of optimization parameters.

5. The method of claim 1, wherein iterating updates of the shape and the fiber path using the fixed finite element mesh comprises:
extending a shape velocity into a larger domain of the continuous fiber composite using the fixed finite element mesh.

6. The method of claim 5, wherein extending the shape velocity into the entire domain of the continuous fiber composite using the fixed finite element mesh comprises:
determining a displacement field of each element of the continuous fiber composite;
determining, using the displacement field of each element, an adjoint variable to determine a gradient of each element of the continuous fiber composite; and
determining the shape velocity using the adjoint variable.

7. The method of claim 1, wherein iterating updates of the shape and the fiber path using the fixed finite element mesh comprises:
a first update of the shape and the fiber path; and
a second update of the shape and the fiber path.

8. The method of claim 7, wherein creating an updated version of the shape and the fiber path when iterating the updates is complete comprises:
comparing the second update of the shape and the fiber path and the first update of the shape and the fiber path to determine that the fixed finite element mesh has completed updating when the second update of the shape and the fiber path and the first update of the shape and the fiber path have converged; and
instantiating, using the second update of the shape and the fiber path, the updated version of the shape and the fiber path.

9. The method of claim 1, wherein iterating optimizations of the shape and the fiber path using the adapted finite element mesh comprises:
a first optimization of the shape and the fiber path; and
a second optimization of the shape and the fiber path.

10. The method of claim 9, wherein creating an optimized version of the shape and the fiber path when iterating the optimizations is complete comprises:
comparing the second optimization of the shape and the fiber path and the first optimization of the shape and the fiber path to determine that the adapted finite element mesh has completed updating when the second optimization of the shape and the fiber path and the first optimization of the shape and the fiber path have converged; and
instantiating, using the second optimization of the shape and the fiber path, the optimized version of the shape and the fiber path.

11. The method of claim 1, wherein iterating optimizations of the shape and the fiber path using the adapted finite element mesh comprises:
extending a shape velocity into an entire domain of the continuous fiber composite using the adapted finite element mesh.

12. The method of claim 11, wherein extending the shape velocity into the entire domain using the adapted finite element mesh comprises:
determining, using a state equation, a displacement field of each element of the continuous fiber composite;
determining, using the displacement field of each element, an adjoint variable with an adjoint equation to determine a gradient of each element of the continuous fiber composite; and
determining the shape velocity using the adjoint variable in a velocity equation.

13. The method of claim 1, wherein generating, using the optimized version of the shape and the fiber path, a specified design of the continuous fiber composite comprises:
detecting a skeleton element of the optimized version of the shape and the fiber path; and
revising the detected skeleton element by aligning the detected skeleton element with adjacent skeleton elements in a normal direction.

14. The method of claim 1, wherein the adapted finite element mesh includes a thickness penalty term, the thickness penalty term to implement a thickness control of the continuous fiber composite.

15. A method of optimizing a shape and a fiber path for a continuous fiber composite, the method comprising:
creating, using a fixed finite element mesh, an updated version of the shape and the fiber path;
creating, using a adapted finite element mesh, an optimized version of the shape and the fiber path from the updated version of the shape and the fiber path; and
generating, using the optimized version of the shape and the fiber path, a specified design of the continuous fiber composite.

16. The method of claim 15, wherein creating, with a fixed finite element mesh, an updated version of the shape and the fiber path comprises:
generating a first update of the shape and the fiber path;
generating a second update of the shape and the fiber path;
comparing the second update of the shape and the fiber path and the first update of the shape and the fiber path to determine that the fixed finite element mesh has completed updating when the second update of the shape and the fiber path and the first update of the shape and the fiber path have converged; and
instantiating, using the second update of the shape and the fiber path, an updated version of the shape and the fiber path.

17. The method of claim 16, wherein generating a first update of the shape and the fiber path and generating a second update of the shape and the fiber path comprises:
determining, using a state equation, a displacement field of each element of the continuous fiber composite;
determining, using the displacement field of each element, an adjoint variable with an adjoint equation to determine a gradient of each element of the continuous fiber composite;
determining a shape velocity using the adjoint variable in a shape velocity equation; and
extending the shape velocity into an entire domain of the continuous fiber composite using the fixed finite element mesh.

18. The method of claim 15, wherein creating, with a adapted finite element mesh, an optimized version of the shape and the fiber path from the updated version of the shape and the fiber path comprises:
generating a first optimization of the shape and the fiber path;
generating a second optimization of the shape and the fiber path;
comparing the second optimization of the shape and the fiber path and the first optimization of the shape and the fiber path to determine that the adapted finite element mesh has completed updating when the second optimization of the shape and the fiber path and the first optimization of the shape and the fiber path have converged; and
instantiating, using the second optimization of the shape and the fiber path, an optimized version of the shape and the fiber path.

19. The method of claim 18, wherein generating a first optimization of the shape and the fiber path and generating a second optimization of the shape and the fiber path comprises:
determining, using a state equation, a displacement field of each element of the continuous fiber composite;
determining, using the displacement field of each element, an adjoint variable with an adjoint equation to determine a gradient of each element of the continuous fiber composite;
determining a shape velocity using the adjoint variable in a velocity equation; and
extending the shape velocity into an entire domain of the continuous fiber composite using the adapted finite element mesh.

20. An apparatus or article of manufacture optimized using the method of claim 15.
